(19) United States
(12) Patent Application Publication
(10) Pub. No.: US 2025/0286735 A1
(43) Pub. Date: Sep. 11, 2025

(54) COMMUNICATION SYSTEM, TERMINAL DEVICE, COMMUNICATION DEVICE, AND METHOD

(71) Applicant: Kabushiki Kaisha Toshiba, Tokyo (JP)

(72) Inventors: Yasuyuki TANAKA, Kawasaki (JP); Sakie NAGAKUBO, Kawasaki (JP); Toshio ITO, Yokohama (JP); Suh WUK KIM, Tokyo (JP)

(73) Assignee: Kabushiki Kaisha Toshiba, Tokyo (JP)

(21) Appl. No.: 19/060,055

(22) Filed: Feb. 21, 2025

(30) Foreign Application Priority Data
Mar. 11, 2024 (JP) 2024-036632

(51) Int. Cl. H04L 9/32

(52) U.S. Cl. CPC H04L 9/3268; H04L 9/3247

(57) ABSTRACT

A communication system includes a communication device, a terminal device, and a certificate authority is provided. The communication device transmits, to the terminal device, a certificate signing request for requesting issuance of a certificate used for the communication device to communicate with the first server device. The terminal device transmits the certificate signing request transmitted from the communication device to the certificate authority. The certificate authority issues a certificate in response to the certificate signing request transmitted from the terminal device. The certificate issued by the certificate authority is transmitted from the certificate authority to the communication device via the terminal device, and is registered in the communication device.

### CROSS-REFERENCE TO RELATED APPLICATION(S)

This application is based upon and claims the benefit of priority from Japanese Patent Application No. 2024-036632, filed Mar. 11, 2024, the entire contents of which are incorporated herein by reference.

### FIELD

Embodiments described herein relate generally to a communication system, a terminal device, a communication device, and a method.

### BACKGROUND

In a technology called IoT (Internet Of Things), various IoT services can be realized by connecting an edge device (communication device, communication circuitry or communicator) to a network.

In order for the edge device to communicate with a server device or the like that provides an IoT service via a network, a certificate for ensuring security in the communication (for example, a certificate for a public key of the edge device in a public key encryption scheme) is required. However, for example, it takes time and effort for a user who owns the edge device to issue and register the certificate.

### DESCRIPTION OF THE DRAWINGS

FIG. 1 is a diagram showing an example of a system configuration of a communication system according to a first embodiment.

FIG. 2 is a diagram showing an example of a functional configuration of an edge device.

FIG. 3 is a diagram showing an example of a data structure of device management information.

FIG. 4 is a diagram showing an example of a functional configuration of a user terminal.

FIG. 5 is a diagram showing an example of a data structure of user information.

FIG. 6 is a diagram showing an example of a data structure of server information.

FIG. 7 is a diagram showing an example of a functional configuration of a certificate authority.

FIG. 8 is a diagram showing an example of a hardware configuration of an edge device.

FIG. 9 is a sequence chart showing an example of a processing procedure of the communication system.

FIG. 10 is a view showing an example of a device confirmation screen.

FIG. 11 is a diagram showing an example of a data structure of verification information.

FIG. 12 is a diagram showing another example of the data structure of verification information.

FIG. 13 is a diagram showing still another example of the data structure of verification information.

FIG. 14 is a diagram showing still another example of the data structure of verification information.

FIG. 15 is a diagram showing an example of the data structure of issuance history information.

FIG. 16 is a diagram showing an outline of issuance of a public key certificate in a comparative example of the present embodiment.

FIG. 17 is a diagram showing an outline of issuance of a public key certificate in the present embodiment.

FIG. 18 is a diagram showing an example of a system configuration of a communication system according to a second embodiment.

FIG. 19 is a diagram showing an example of a functional configuration of a user terminal.

FIG. 20 is a sequence chart showing an example of a processing procedure of the communication system.

FIG. 21 is a diagram showing an example of a system configuration of a communication system according to a third embodiment.

### DETAILED DESCRIPTION

In general, according to an embodiment, a communication system is provided which includes a communication device, a terminal device, and a certificate authority. The communication device transmits, to the terminal device, a certificate signing request for requesting issuance of a certificate used for the communication device to communicate with a first server device. The terminal device transmits the certificate signing request transmitted from the communication device to the certificate authority. The certificate authority issues the certificate in response to a certificate signing request transmitted from the terminal device. The certificate issued by the certificate authority is transmitted from the certificate authority to the communication device via the terminal device, and is registered in the communication device.

Hereinafter, embodiments of the present disclosure will be described with reference to the drawings. The embodiments do not limit the present disclosure. The drawings are schematic or conceptual, and the ratio of each portion is not necessarily the same as the actual ratio. In the specification and the drawings, the same reference numerals are given to the same elements as those described in the drawings, and the detailed description thereof will be appropriately omitted.

### First Embodiment

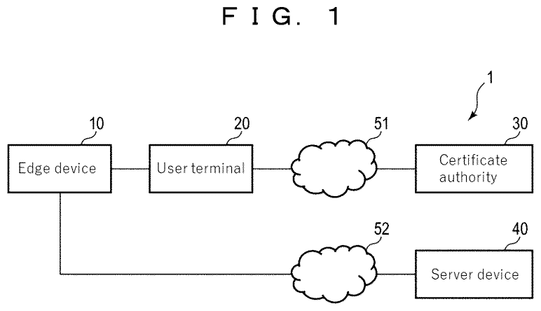

First, a first embodiment will be described. FIG. 1 shows an example of a system configuration of a communication system according to the present embodiment. As illustrated in FIG. 1, the communication system 1 includes an edge device 10, a user terminal 20 (client terminal), a certificate authority 30, and a server device 40. While only one user terminal 20 is illustrated in FIG. 1, a plurality of user terminals 20 may be used, if desired.

The edge device 10 is a device used in a technology called IoT, and is equipped with a host controller configured to control the operation of the edge device 10 and a communication device configured to provide a communication function to the edge device 10.

The host controller and the communication device are connected via connection interfaces provided in the edge devices 10, such as USB-connectors or pin slot connectors, and communication may be performed between the host controller and the communication device in a serial manner, using protocols such as I2C (“Inter-Integrated Circuit” protocol), URT (“Ultra Real-Time” protocol), and SPI (“Serial Peripheral Interface” protocol), or in a parallel manner.

In the present embodiment, the edge device 10 includes an IoT device, a personal computer (PC), a gateway, or the like. The edge device 10 operates as a part of an application system for providing various IoT services by executing communication with the server device 40. However, the edge device 10 in the present embodiment is in a factory shipment state, and thus the settings necessary for executing communication with the server device 40 are not performed. The edge device 10 in the factory shipment state may be a device that has been used for another purpose in the past and then brought into the factory shipment state (that is, initialized) by a predetermined operation.

The user terminal 20 may be implemented as a handheld terminal such as a smartphone or a tablet terminal used by a user who owns the edge device 10, for example, but may be a terminal device of another form such as a PC. The user terminal 20 includes a user interface that receives an input from a user and presents information to the user.

The certificate authority 30 issues a certificate used for the edge device 10 to communicate with the server device 40. Specifically, when a public key encryption scheme is adopted to ensure security in communication performed between the edge device 10 and the server device 40, the certificate authority 30 issues a certificate for the public key of the edge device 10 in the public key encryption scheme (a public key certificate of the edge device 10). When the public key certificate issued by the certificate authority 30 is registered in the edge device 10, the edge device 10 can communicate with the server device 40 using the public key certificate.

The server device 40 operates to provide various IoT services by executing communication with the edge device 10. Specifically, the server device 40 may operate to register the sensor data collected by the edge device 10 in the server device 40, or may operate to issue a command to the edge device 10 and cause the edge device 10 to execute a predetermined process. Further, the server device 40 may transmit firmware or software operating on the edge device 10 to the edge device 10 and instruct the edge device 10 to update the firmware or the software.

The processing of the server device 40 described above may be executed on a server computer managed in an on-premise manner in a base such as an office, or may be executed on a virtual machine implemented on the computer. The processing of the server device 40 may be executed on a cloud board in a communication network provided by a cloud service provider or the like or on the Internet.

Note that a communication scheme applied to communication between the edge device 10 and the user terminal 20 illustrated in FIG. 1 may be a wireless communication scheme or a wired communication scheme. As a wireless communication scheme, for example, Bluetooth (registered trademark), Wi-Fi (registered trademark), ZigBee (registered trademark), or infrared communication may be used, but the wireless communication scheme is not limited thereto. The wired communication scheme may be Ethernet (registered trademark), serial communication using a universal asynchronous receiver transmitter (UART), a controller area network (CAN), or the like, but is not limited thereto.

The user terminal 20 and the certificate authority 30 shown in FIG. 1 are connected to each other via a network 51 so as to be able to communicate with each other. The edge device 10 and the server device 40 illustrated in FIG. 1 are communicably connected to each other via a network 52.

The communication scheme applied to the communication between the user terminal 20 and the network 51 and the communication scheme applied to the communication between the edge device 10 and the network 52 may be a wireless communication scheme or a wired communication scheme, similarly to the communication scheme applied to the communication between the edge device 10 and the user terminal 20 described above.

The network 51 may be a small-scale closed network such as a local area network (LAN), a wide-area closed network such as a wide area network (WAN), or an open network such as the Internet. The user terminals 20 perform communication based on, for example, WiFi or a cellular phone communication scheme (LTE, 5G, or the like) in order to connect to the network 51, but may be configured to perform communication based on another standard. The network 51 has been described here, but the same applies to the network 52. The networks 51 and 52 may be different networks or the same network.

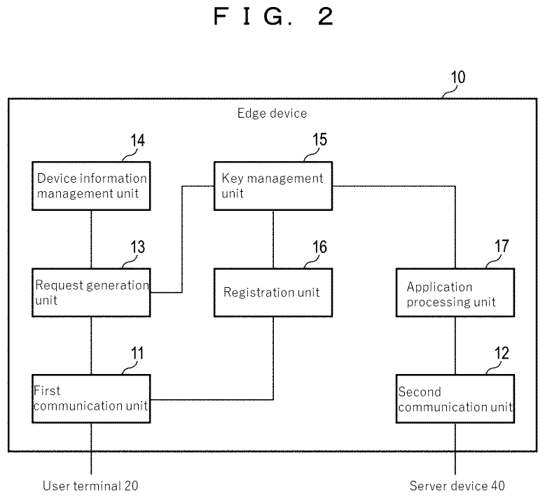

FIG. 2 shows an example of a functional configuration of the edge device 10 shown in FIG. 1. As illustrated in FIG. 2, the edge device 10 includes a first communication unit 11, a second communication unit 12, a request generation unit 13, a device information management unit 14, a key management unit 15, a registration unit 16, and an application processing unit 17.

The first communication unit 11 communicates with the user terminal 20 in accordance with a predetermined communication scheme. The second communication unit 12 communicates with the server device 40 via the network 52.

Although the first and second communication units 11 and 12 are shown as independent and separate functional units in FIG. 2, the first and second communication units 11 and 12 may be realized as a single functional unit. The communication scheme for the first communication unit 11 to perform communication may be different from or the same as the communication scheme for the second communication unit 12 to perform communication.

The request generation unit 13 generates a certificate signing request for requesting issuance of a public key certificate in accordance with an instruction from the user terminal 20 described later. The certificate signing request generated by the request generation unit 13 is transmitted to the user terminal 20 via the first communication unit 11.

The device information management unit 14 manages information (hereinafter, referred to as device management information) related to the edge device 10.

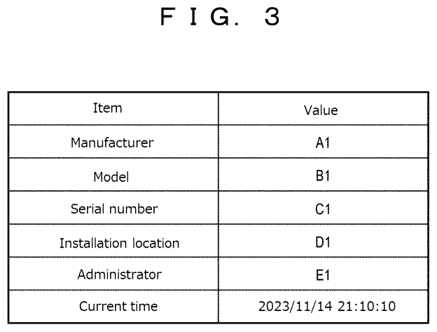

FIG. 3 shows an example of the data structure of the device management information. In the example illustrated in FIG. 3, the device management information includes, for example, a manufacturer, a model, a serial number, an installation location, an administrator, and a current time and/or date of the edge device 10.

The manufacturer, the model, and the serial number are, for example, information embedded in advance at the time of manufacturing the edge device 10 (that is, information registered in advance in the edge device 10). The installation location and the administrator are information provided from the user terminal 20, for example. The current time is initialized by information provided from the user terminal 20, for example, and is automatically updated with the passage of time.

In FIG. 3, the device management information is described as including the manufacturer, model, serial number, installation location, administrator, and current time, but the device management information may omit some of or all of these pieces of information, or may include additional information (for example, model number, hardware version, and the like).

The key management unit 15 manages a public key and a secret key (key pair) of the edge device 10 in the public key encryption scheme. The certificate signing request generated by the request generation unit 13 includes the public key of the edge device 10 managed by the key management unit 15.

Here, the key pair of the edge device 10 may be generated in response to an instruction from the request generation unit 13, for example, when the request generation unit 13 generates the certificate signing request, for example, but may be generated when the power of the edge device 10 in a factory shipment state is turned on, for example. The key pair of the edge device 10 may be generated in accordance with an instruction from the user terminal 20. Further, the key pair of the edge device 10 may be held in advance inside the edge device 10. In addition, when the key management unit 15 is implemented as a security module of hardware such as a secure element, the key pair of the edge device 10 may be generated by the hardware.

Although the key management unit 15 is described as mainly managing the key pair of the edge device 10, the key management unit 15 may execute encryption processing and signature processing based on the public key encryption scheme.

The registration unit 16 executes a process of registering the public key certificate issued by the certificate authority 30 in response to the certificate signing request generated by the request generation unit 13 in the edge device 10 (the key management unit 15).

The application processing unit 17 executes authentication processing (hereinafter, referred to as device authentication processing) for the edge device 10 with the server device 40 by using the public key certificate registered in the edge device 10.

When the edge device 10 is authenticated by executing the device authentication process (that is, when the authentication is successful), the application processing unit 17 executes communication (application communication) with the server device 40 via the second communication unit 12. The application processing unit 17 executes processing (application processing corresponding to application communication) on the edge device 10 side for providing the IoT service. In this case, the application processing unit 17 may execute processing of acquiring sensor data from a sensor mounted on the edge device 10 and transmitting the sensor data to the server device 40, for example. The application processing unit 17 may execute a command on the edge device 10 in accordance with an instruction from the server device 40 or may execute processing of operating an actuator connected to the edge device 10. Further, the application processing unit 17 may execute processing of updating firmware or software of the edge device 10 in accordance with an instruction from the server device 40.

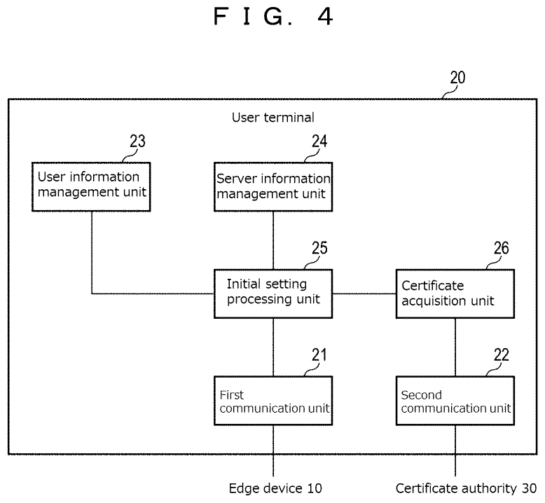

FIG. 4 shows an example of a functional configuration of the user terminal 20 shown in FIG. 1. As illustrated in FIG. 4, the user terminal 20 includes a first communication unit 21, a second communication unit 22, a user information management unit 23, a server information management unit 24, an initial setting processing unit 25, and a certificate acquisition unit 26.

The first communication unit 21 communicates with the edge device 10 in accordance with a predetermined communication scheme. The second communication unit 22 communicates with the certificate authority 30 via the network 51.

Although the first and second communication units 21 and 22 are shown as independent and separate functional units in FIG. 4, the first and second communication units 21 and 22 may be realized as a single functional unit. The communication scheme for the first communication unit 21 to perform communication may be different from or the same as the communication scheme for the second communication unit 22 to perform communication.

The user information management unit 23 manages information (hereinafter, referred to as user information) related to a user (a user who uses the user terminal 20) who owns the edge device 10.

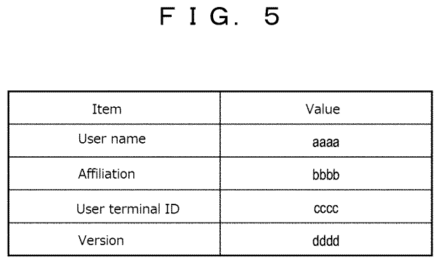

FIG. 5 shows an example of the data structure of the user information. As illustrated in FIG. 5, the user information includes, for example, the user name of the user, the affiliation of the user, the user terminal ID for identifying the user terminal 20, and the version of the user terminal 20.

The user name and the affiliation are information set by the user, for example. The user terminal ID and the version are, for example, information embedded in advance at the time of manufacturing the user terminal 20 (that is, information registered in advance in the user terminal 20).

Although the user information includes the user name, the affiliation, the user terminal ID, and the version in FIG. 5, the user information may omit a part of or all of these pieces of information or may include additional information.

The server information management unit 24 manages information (hereinafter, referred to as server information) on the server device 40.

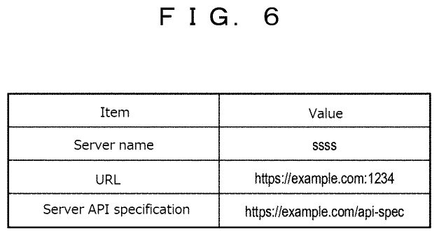

FIG. 6 shows an example of the data structure of the server information. As illustrated in FIG. 6, the server information includes, for example, a server name of the server device 40, a uniform resource locator (URL) for accessing the server device 40, and a specification of an application programming interface (API) (server API specification) implemented in the server device 40.

The server ID, the URL, and the server API specification may be, for example, information set by the user or information provided from the outside of the user terminal 20 (for example, the server device 40 or the like).

Although the server information is described as including the server name, the URL, and the server API specification in FIG. 6, the server information may include some of these pieces of information or may include additional information.

The initial setting processing unit 25 executes processing related to the initial setting of the edge device 10. Specifically, when the user terminal 20 is connected to the edge device 10, the initial setting processing unit 25 instructs the edge device 10 to generate a certificate signing request. The initial setting processing unit 25 provides the edge device 10 with (a part of) the user information and the server information described above as information to be set in the edge device 10 (hereinafter, referred to as setting information) in a series of initial settings of the edge device 10.

The initial setting processing unit 25 receives a certificate signing request transmitted from the edge device 10 via the first communication unit 21. The initial setting processing unit 25 verifies the received certificate signing request.

When the verification of the certificate signing request by the initial setting processing unit 25 is successful, the certificate acquisition unit 26 transmits the certificate signing request to the certificate authority 30 via the second communication unit 22. The certificate acquisition unit 26 receives the public key certificate of the edge device 10 issued by the certificate authority 30 in response to the certificate signing request via the second communication unit 22.

The public key certificate received by the certificate acquisition unit 26 in this way is passed to the initial setting processing unit 25, and is transmitted to the edge device 10 via the first communication unit 21.

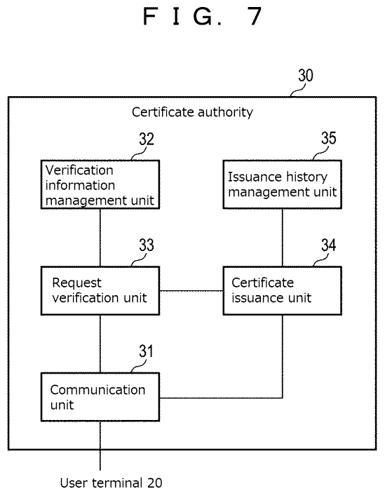

FIG. 7 shows an example of a functional configuration of the certificate authority 30 shown in FIG. 1. As shown in FIG. 7, the certificate authority 30 includes a communication unit 31, a verification information management unit 32, a request verification unit 33, a certificate issuance unit 34, and an issuance history management unit 35.

The communication unit 31 communicates with the user terminal 20 via the network 51. The verification information management unit 32 manages information (hereinafter, referred to as verification information) used for verifying the certificate signing request transmitted from the user terminal 20. The verification information includes, for example, information about a device owned by the user to which a public key certificate can be issued.

The request verification unit 33 receives a certificate signing request transmitted from the user terminal 20 via the communication unit 31. The request verification unit 33 verifies whether the correspondence between the received certificate signing request and the user terminal that is the transmission source of the certificate signing request or the user who is the user of the user terminal is appropriate, using the verification information managed by the verification information management unit 32.

When the verification of the certificate signing request is successful, the certificate issuance unit 34 issues a public key certificate in response to the certificate signing request. The public key certificate issued by the certificate issuance unit 34 is transmitted to the user terminal 20 via the communication unit 31.

The issuance history management unit 35 manages information (hereinafter, referred to as issuance history information) related to public key certificates issued in the past by the certificate issuance unit 34. Whether or not to issue the public key certificate may be determined based on the issue history information (that is, the history of public key certificates issued in the past) managed by the issue history management unit 35.

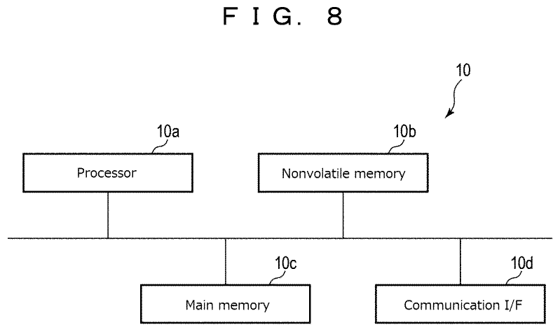

FIG. 8 shows an example of a hardware configuration of the edge device 10. As illustrated in FIG. 8, the edge devices 10 include a processor 10a, a nonvolatile memory 10b, a main memory 10c, a communication interface (I/F) 10d, and the like.

The processor 10a is configured to control the operation of each component in the edge devices 10, and may be, for example, a CPU or the like. The processor 10a may be a single processor or may be configured by a plurality of processors. The processor 10a executes various programs that are loaded from the non-volatile memory 10b into the main memory 10c. The non-volatile memory may be implemented in any desired manner including using a semiconductor-based device such as a ROM (Read Only Memory) or a hard-disk drive, for example. The main memory may be implemented using any desired type of memory including using RAM (Random Access Memory), a hard disk drive, or a solid state drive, for example. The communication interface 10d is an interface for realizing communication with the user terminals 20 and the server device 40, for example.

In the present embodiment, some or all of the units 11 to 17 illustrated in FIG. 2 may be implemented using the processor 10a illustrated in FIG. 8 which executes a predetermined software program (application program), may be implemented by hardware such as integrated circuits (ICs), and may be implemented by a configuration in which software and hardware are combined.

Although the hardware configuration of the edge device 10 has been described here, the user terminal 20 and the certificate authority 30 may be implemented to have substantially the same hardware configuration.

In this case, some or all of the units 21 to 26 illustrated in FIG. 4 may be realized using a processor (CPU) included in the user terminal 20 which executes a predetermined program, may be realized by hardware, and may be realized by a configuration in which software and hardware are combined.

A part or all of the units 31 to 35 illustrated in FIG. 7 may be realized using a processor (CPU) included in the certificate authority 30 which executes a predetermined program, may be realized by hardware, or may be realized by a configuration in which software and hardware are combined.

In the present embodiment, the user terminal 20 further includes an input device such as a keyboard and mouse, a display device, and the like for realizing the user interface.

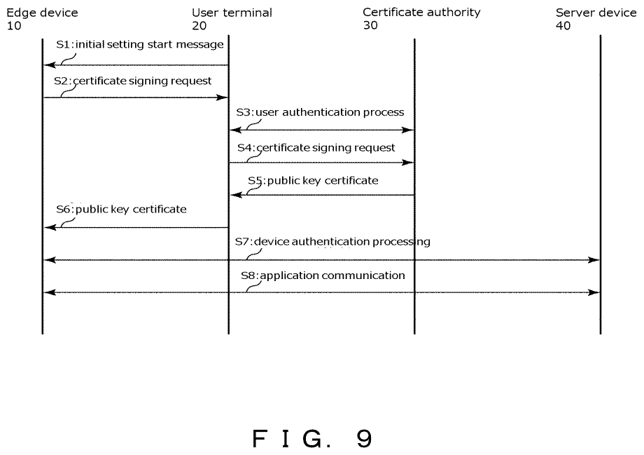

Hereinafter, an example of a processing procedure of the communication system 1 according to the present embodiment will be described with reference to a sequence chart of FIG. 9.

In the present embodiment, the edge device 10 may be implemented in a factory shipment state, and at least a public key certificate used for the edge device 10 to communicate with the server device 40 is not registered in the edge device 10 at the start of the sequence. The communication system 1 according to the present embodiment operates to realize issuance and registration of a public key certificate of the edge device 10 described above using the user terminal 20.

First, for example, when the power of the edge device 10 in a factory shipment state is turned on, the edge device 10 enters an initial setting standby state, and the edge device 10 and the user terminal 20 are communicably connected to each other in response to a user operation on the user terminal 20. When the user terminals 20 are connected to the edge devices 10 in this way, the initial setting processing unit 25 included in the user terminals 20 transmits a message requesting the start of the initial setting of the edge devices 10 (hereinafter, referred to as an initial setting start message) to the edge devices 10 via the first communication unit 21 (step S1). Note that, by executing the process of step S1, the user terminals 20 instruct the edge devices 10 to generate a certificate signing request.

When the initial setting start message is transmitted in step S1, for example, the setting information (information to be set in the edge devices 10) acquired from the user information managed by the user information management unit 23 may be provided from the user terminals 20 to the edge devices 10.

Further, when the edge device 10 does not have a real-time clock, the initial setting start message may include information of the current time provided from the user. According to this, the edge device 10 can set the internal clock in the edge device 10 based on the information of the current time included in the initial setting start message.

The initial setting start message may include information designated by the user. The information designated by the user includes, for example, an identifier (user ID) for identifying the user, a random character string for nonce purpose, and the like.

Although it has been described that various information may be included in the initial setting start message, such information may be included in another message following the initial setting start message.

When the process of step S1 is executed, the request generation unit 13 included in the edge devices 10 receives the initial setting start message transmitted in step S1 via the first communication unit 11.

The request generation unit 13 generates a certificate signing request for requesting issuance of a public key certificate in response to the received initial setting start message (i.e., an instruction to generate a certificate signing request). The certificate signing request generated by the request generation unit 13 is, for example, a CSR (Certificate Signing Request) according to PKCS #10 (RFC2986) of PKCS (Public-Key Cryptography Standards).

The certificate signing request includes the public key of the edge device 10 managed by the key management unit 15, but may further include, for example, device information (a manufacturer, a model number, a model, a serial number, a hardware version, and the like of the edge device 10) managed by the device information management unit 14.

The certificate signing request may include a part of various information included in the initial setting start message (for example, user information provided from the user terminal 20), the date and time when the certificate signing request is generated, and the like. According to this, by referring to (information included in) the certificate signing request, it is possible to determine the user who instructed the generation of the certificate signing request and the date and time when the certificate signing request was generated (that is, the date and time when the initial setting of the edge device 10 was started). The certificate signing request may include device information managed by the device information management unit 14.

When the process of step S2 is executed, the initial setting processing unit 25 included in the user terminal 20 receives the certificate signing request transmitted in step S2 via the first communication unit 21.

The initial setting processing unit 25 verifies the received certificate signing request. In this case, the verification of the certificate signing request succeeds when the user information provided by the user terminal 20 is included in the certificate signing request, and fails when the user information is not included in the certificate signing request, for example. Note that the certificate signing request may be verified based on other information.

The initial setting processing unit 25 passes the certificate signing request to the certificate acquisition unit 26 when the verification of the certificate signing request is successful, and discards the certificate signing request when the verification of the certificate signing request fails. When the certificate signing request is discarded, the initial setting processing unit 25 may notify the user of an error.

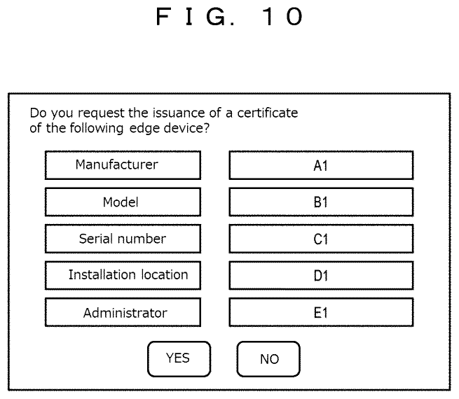

The certificate signing request may be verified by the user confirming the contents of the certificate signing request. In this case, the user terminal 20 presents the device information included in the certificate signing request to the user on a screen (hereinafter, referred to as a device confirmation screen) as illustrated in FIG. 10, for example. Accordingly, the user can confirm whether the certificate signing request received by the user terminal 20 is the certificate signing request generated by the edge device 10 intended by the user.

For example, when the device information displayed on the device confirmation screen matches the device information (e.g., the serial number) printed on the housing of the edge device 10, the user instructs to request issuance of the public key certification (i.e., to execute the processing in step S3 and subsequent steps).

When the verification of the certificate signing request is successful, the certificate acquisition unit 26 performs a user authentication process with the certificate authority 30 (the communication unit 31) (step S3). The user authentication process corresponds to a process of transmitting, for example, a user ID, a password, and the like assigned to the user who uses the user terminal 20 from the user terminal 20 to the certificate authority 30 and confirming whether the user is a valid user who can request issuance of a public key certificate in the certificate authority 30. Although the user ID and the password are used in the user authentication process in the above description, the user authentication process may be any process for authenticating the user (or the user terminal 20), and other information may be used.

When the user is authenticated by the process of step S3 (i.e., when the user is confirmed to be a valid user in the user authentication process), the certification acquisition unit 26 transmits a certification signing request to the certificate authority 30 via the second communication unit 22 (step S4).

When the process of step S4 is executed, the request verification unit 33 included in the certificate authority 30 receives the certificate signing request transmitted in step S4 via the communication unit 31.

The request verification unit 33 verifies the received certificate signing request based on the verification information managed by the verification information management unit 32. When the edge device 10 to be the target of the certificate signing request (that is, the edge device 10 capable of requesting the issuance of the public key certificate) and the attribute information of the certificate are set in advance by the user, for example, in the verification of the certificate signing request, it may be confirmed whether the edge device 10 or the attribute information is appropriate. The attribute information in this case includes, for example, information of the installation location of the edge device 10, the administrator, and the like.

The certificate signing request may be verified by checking whether the data structure of the certificate signing request or information included in the certificate signing request conforms to the specification requested by the certificate authority 30.

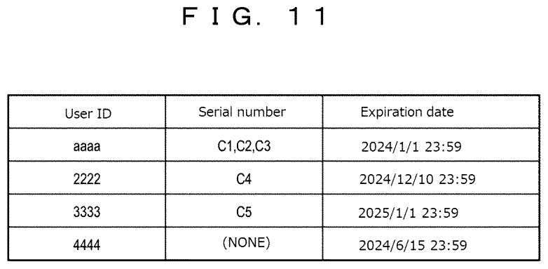

An example of the verification of the certificate signing request performed by the certificate authority 30 as described above will be described below. First, FIG. 11 shows an example of the data structure of verification information. In the example illustrated in FIG. 11, the verification information includes a user ID for identifying a user, a serial number of the edge device 10 owned by the user, and an expiration date of the verification information in association with each other.

Here, if the certificate signing request received by the request verification unit 33 includes user information (for example, a user ID) and device information (for example, a serial number), the certificate signing request is successfully verified when the user ID and the serial number match (that is, there is verification information including the user ID and the serial number included in the certificate signing request in association with each other) as a result of comparison between the certificate signing request and the verification information. The verification of the certificate signing request fails when at least one of the user ID and the serial number does not match as a result of the comparison between the certificate signing request and the verification information (that is, when the verification information including the user ID and the serial number included in the certificate signing request in association with each other does not exist).

Although the certificate signing request includes the user information in the above description, the certificate signing request may not include the user information. The communication unit 31 has executed the user authentication process with the user terminals 20 (the certification acquisition unit 26) in step S3 described above, and holds the user information (user IDs and the like) used in the user authentication process. Therefore, as described above, when the user information is not included in the certificate signing request, the user request verification unit 33 acquires the user information from the provided communication unit 31 and uses the user information for verification of the certificate signing request.

Note that, as described above, the validation information includes the expiration date, but validation information whose expiration date has expired may be discarded or may be updated to validation information including a new expiration date.

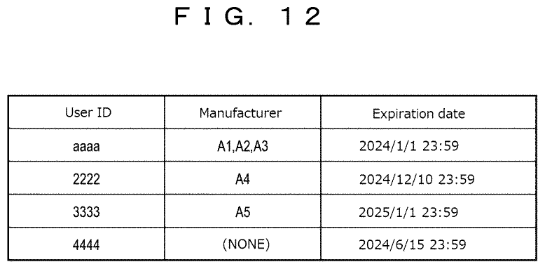

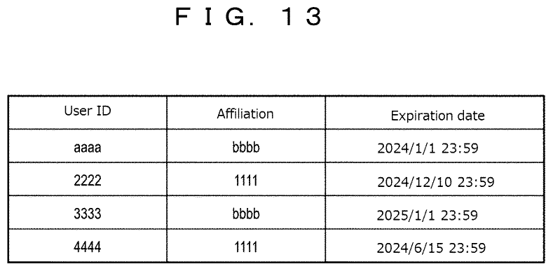

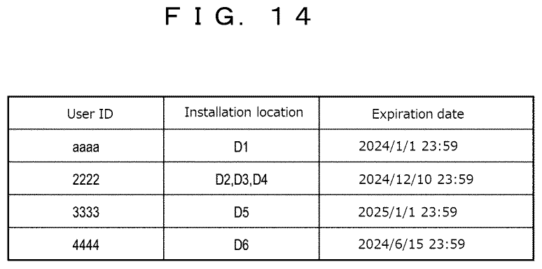

Although the verification information is described as information including the user ID and the serial number in association with each other, the verification information may be information including the user ID and the manufacturer of the edge device 10 in association with each other as shown in FIG. 12, information including the user ID and the affiliation of the user in association with each other as shown in FIG. 13, or information including the user ID and the installation location of the edge device 10 in association with each other as shown in FIG. 14. Even in the case of the verification information as illustrated in FIGS. 12 to 14, the certificate signing request can be verified by comparing the certificate signing request with the verification information.

The verification information managed by the verification information management unit 32 may be information having a data structure in which the above described FIGS. 11 to 14 are combined.

That is, in the present embodiment, it can be said that the edge device 10 capable of issuing the public key certificate is limited or designated according to the authority set in advance for the user (user terminal 20) by the above described verification information.

The request verification unit 33 passes the certificate signing request to the certificate issuance unit 34 when the verification of the certificate signing request is successful, and discards the certificate signing request when the verification of the certificate signing request fails. Note that, when the certificate signing request is discarded, the request verification unit 33 may notify the user terminal 20 (the user who uses the user terminal 20) of an error via the communication unit 31.

As described above, when the verification of the certificate signing request is successful, the certificate issuance unit 34 takes over the process from the request verification unit 33, and issues the public key certificate of the edge device 10 in response to the certificate signing request passed from the request verification unit 33. When the public key certificate is issued by the certificate issuance unit 34 in this way, the issuance history information related to the issued public key certificate is managed by the issuance history management unit 35. The public key certificates of the edge devices 10 issued by the certification issuance unit 34 in this way are transmitted (provided) to the user terminals 20 via the communication unit 31 (step S5).

Note that the above description has been given assuming that the public key certificate is issued when the verification of the certificate signing request is successful. However, if the certificate issuance unit 34 has processed exactly the same certificate signature request as the one currently processed and/or has processed a request with exactly the same content including a time stamp and the like in the past based on the issue history information (history of public key certificates issued in the past) managed by the issue history management unit 35 and has issued a certificate at that time, the certificate issuance unit 34 may interrupt the current processing and may not issue a new public key certificate, if desired.

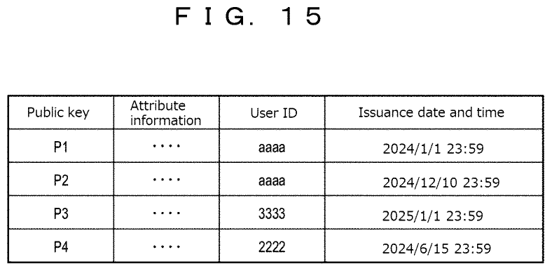

FIG. 15 shows an example of the data structure of the issuance history information. As illustrated in FIG. 15, the issuance history information includes a public key for which a public key certificate has been issued in the past, attribute information of the public key certificate, a user ID for identifying a user who has requested the issuance of the public key certificate, and a date and time when the public key certificate has been issued (issuance date and time) in association with each other. The attribute information includes, for example, information such as an identifier and/or an installation location of the edge device 10.

According to the issuance history information shown in FIG. 15, the certificate issuance unit 34 can confirm whether a certificate for the same public key as the public key for which issuance of a public key certificate is requested by the certificate signing request has been issued in the past (that is, whether issuance history information including the same public key as the certificate signing request and attribute information has already been managed by the issuance history management unit 35) by referring to the issuance history information. Specifically, for example, if the certificate signing request includes the date and time when the certificate signing request is generated (hereinafter referred to as request generation date and time), when the public key and the attribute information included in the issuance history information including the issuance date and time before the request generation date and time match the public key and the attribute information included in the certificate signing request, it is found that the certificate for the same public key has been issued in the past.

When it is confirmed that a certificate for the same public key has been issued in the past, the certificate issuance unit 34 may discard the certificate signing request without issuing a public key certificate in response to the certificate signing request. In this case, the certificate issuance unit 34 may notify (the user who uses) the user terminal 20 that the certificate signing request has been discarded, or may notify an alert to the administrator of the certificate authority 30, via the communication unit 31.

Although it has been described that a public key certificate is not issued when a certificate for the same public key has already been issued, a serial number or a random number of the public key certificate may be embedded in the attribute information (that is, the attribute information may be changed by the serial number or the random number), so that the public key certificate can be reissued even for the same public key.

When the process of step S5 is executed, the certification acquisition unit 26 included in the user terminal 20 receives (acquires) the public key certification transmitted in step S5 via the second communication unit 22. The public key certificates received by the certification acquisition unit 26 are passed to the initial setting processing unit 25 and transmitted to the edge devices 10 via the first communication unit 21 (step S6).

When the process of step S6 is executed, the registration unit 16 included in the edge devices 10 receives the public key certificates transmitted in step S6 via the first communication unit 11. The public key certificate received by the registration unit 16 is registered (set) in the edge device 10. Thus, the initial setting of the edge device 10 is completed.

In step S6, setting information (for example, server information managed by the server information management unit 24) for the edge devices 10 to communicate with the server device 40 may be transmitted together with the public key certificates, and the setting information may be set in the edge devices 10.

When the public key certificates are registered in the edge devices 10 as described above, the edge devices 10 and the server device 40 perform the device authentication process using the public key certificates (step S7). In step S7, for example, a device authentication process may be executed to confirm whether the public key certificates presented from the edge devices 10 are the public key certificates legitimately issued for the public keys of the edge devices 10.

When the edge devices 10 are authenticated by the execution of the process in step S7, the application processing units 17 included in the edge devices 10 start the execution of application communication with the server device 40. The edge devices 10 and the server device 40 operate in cooperation with each other as an application system through such application communication, thereby realizing provision of the IoT service (step S8).

The key management unit 15 included in the edge device 10 may generate an electronic signature to be attached to the certificate signing request by using the secret key of the edge device 10 managed by the key management unit 15. The electronic signature is generated by, for example, performing encryption processing on the hash value of the certificate signing request using the secret key of the edge device 10.

In this case, a certificate signing request with an electronic signature attached thereto is transmitted from the edge device 10 to the user terminal 20, and the initial setting processing unit 25 included in the user terminal 20 can verify the certificate signing request using the electronic signature. In the verification of the certificate signing request, a process of calculating a hash value of the certificate signing request and collating the calculated hash value with a result (hash value) of performing an encryption process on the electronic signature attached to the certificate signing request using a public key (public key of the edge device 10) paired with the private key of the edge device 10 is executed. In this case, when the hash value of the certificate signing request and the hash value obtained from the electronic signature match, it can be confirmed that the certificate signing request has been successfully verified.

Although the above description has been made on the assumption that the electronic signature generated in the edge device 10 is attached to the certificate signing request transmitted from the edge device 10 to the user terminal 20, the electronic signature generated using the private key of the user terminal 20 may be attached to the certificate signing request transmitted from the user terminal 20 to the certificate authority 30. In this case, the request verification unit 33 included in the certificate authority 30 can verify the certificate signing request by using the electronic signature attached to the certificate signing request transmitted from the user terminal 20 and the public key of the user terminal 20. According to this, it is possible to confirm that the edge device 10 has generated the certificate signing request by the instruction of the user terminal 20.

Further, an electronic signature generated using the private key of the certificate authority 30 may be attached to the public key certificate transmitted from the certificate authority 30 to the user terminal 20. In this case, the certificate acquisition unit 26 included in the user terminal 20 can verify the public key certificate by using the electronic signature attached to the public key certificate transmitted from the certificate authority 30 and the public key of the certificate authority 30. Note that the verification of the public key certificate may be performed by the registration unit 16 included in the edge device 10, for example.

Note that the process shown in FIG. 9 is an example, and in the present embodiment, a process that is partially different from the process described in FIG. 9 may be executed, or a process in which a portion of the process described in FIG. 9 is omitted may be executed.

As described above, in the present embodiment, the edge device 10 (communication device) transmits, to the user terminal 20, a certificate signing request for requesting issuance of a public key certificate (a certificate for a public key of the edge device 10 in the public key encryption scheme) used for the edge device 10 to execute communication with the server device 40. In the present embodiment, the user terminal 20 transmits the certificate signing request transmitted from the edge device 10 to the certificate authority 30. Furthermore, in the present embodiment, the certificate authority 30 issues a public key certificate in response to a certificate signing request transmitted from the user terminal 20. The public key certificate issued by the certificate authority 30 in this way is transmitted from the certificate authority 30 to the edge device 10 via the user terminal 20, and is registered in the edge device 10.

In the present embodiment, with the above-described configuration, it is possible to easily issue and register a public key certificate (a public key certificate used by the edge device 10 for communication) for the edge device 10 in a factory shipment state.

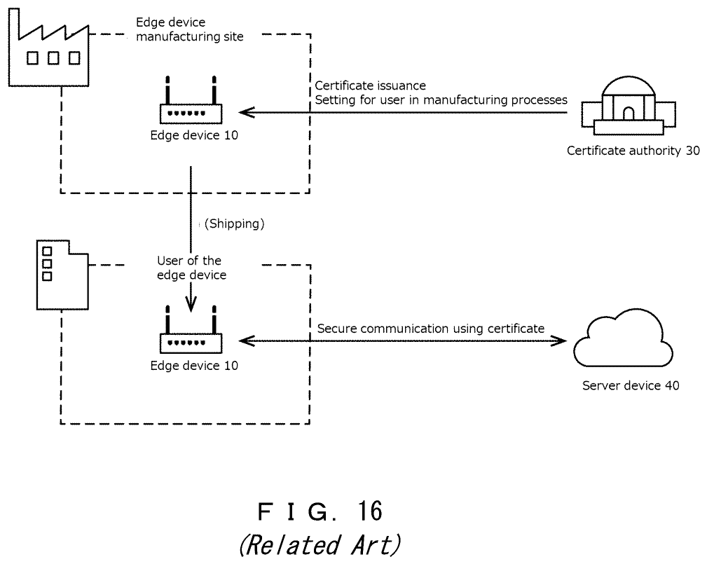

FIG. 16 shows an outline of issuance of a public key certificate in a comparative example. As illustrated in the comparative example of FIG. 16, the setting for the user such as the registration of the public key certificate issued from the certificate authority 30 is completed in the manufacturing site of the edge device 10, and the user can perform communication (secure communication using the certificate) with the server device 40 using the edge device 10 in which the public key certificate is already registered.

However, in the comparative example described above, since the public key certificate is registered in advance in the edge device 10 before being shipped from the factory, for example, the public key certificate cannot be issued in the certificate authority 30 designated by the user. Furthermore, when issuing and registering the public key certificate in advance, it takes time to ship the edge device 10.

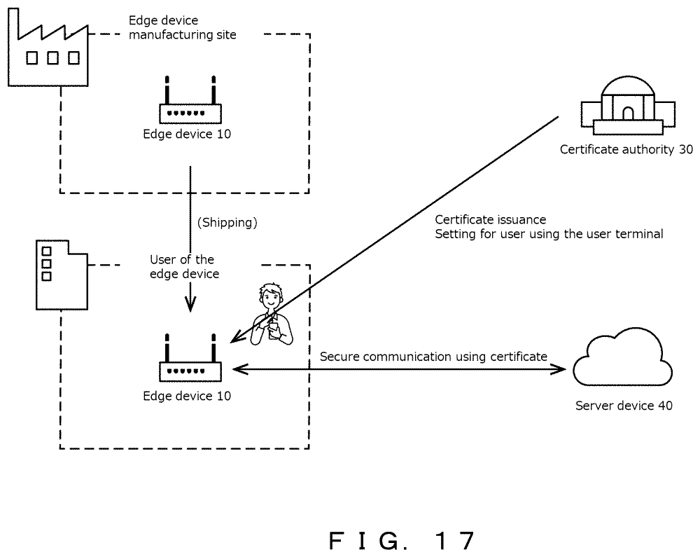

On the other hand, FIG. 17 shows an outline of issuance of a public key certificate in this embodiment. As illustrated in FIG. 17, in the present embodiment, after the edge device 10 for which the public key certificate is not issued and registered in advance is shipped from the factory, the public key certificate of the edge device 10 in the factory shipment state is issued and registered using the user terminal 20.

According to such a configuration, unlike the comparative example described above, the certificate authority 30 designated by the user who owns the edge device 10 (the user who uses the user terminal 20) can be used for issuing and registering the public key certificate.

Furthermore, in the present embodiment, it is not necessary to perform setting for connecting the edge device 10 to the certificate authority 30 in relation to the issuance of the public key certificate, and it is possible to automate the issuance and registration (that is, initial setting) of the public key certificate of the edge device 10 in a factory shipment state. That is, in the present embodiment, since there is no need for specialized knowledge or complicated work relating to the issuance and registration of a public key certificate, it is possible to reduce the time and effort of the user (that is, it is possible to easily perform initial setting including the issuance and registration of a public key certificate).

In addition, in the present embodiment, since it is not necessary to complete the setting for the user such as the issuance and registration of the public key certificate before the factory shipment, it is possible to contribute to the quick shipment of the edge device 10.

In the present embodiment, the user terminal 20 instructs the edge device 10 to generate a certificate signing request when the edge device 10 and the user terminal 20 are communicably connected, and the edge device 10 generates a certificate signing request in response to the instruction from the user terminal 20, thereby enabling the certificate authority 30 to issue a public key certificate using the user terminal 20.

Furthermore, in the present embodiment, the user terminal 20 transmits user information of a user who owns the edge device 10 (a user who uses the user terminal 20) and server information of the server device 40 to the edge device 10, and with the configuration in which the user information and the server information transmitted from the user terminal 20 are set in the edge device 10, it is possible to automatically perform the setting of the edge device 10 based on the information provided from the user terminal 20. In the present embodiment, the user may designate the server device 40 (cloud system) or the like with which the edge device 10 cooperates, in addition to the above described certificate authority 30.

In the present embodiment, the certificate authority 30 verifies the certificate signing request based on, for example, the device information included in the certificate signing request, and issues the public key certificate when the verification of the certificate signing request is successful. According to such a configuration, it is possible to issue a public key certificate of a valid edge device 10.

The certificate signing request may be verified using an electronic signature attached to the certificate signing request. According to such a configuration, for example, it is possible to avoid a situation in which a public key certificate is issued in response to a certificate signing request that has been tampered with or the like, and it is possible to reduce security risks in the IoT service.

Although the verification of the certificate signing request has been described above, the verification of the public key certificate issued from the certificate authority 30 may be performed using, for example, an electronic signature attached to the public key certificate (an electronic signature generated by the certificate authority 30).

In addition, in the present embodiment, by executing the user authentication process for the user who owns the edge device 10 between the user terminal 20 and the certificate authority 30, it is possible to issue a public key certificate in response to a request from a valid user.

Further, in the present embodiment, whether or not to issue a public key certificate may be determined based on issue history information relating to public key certificates issued in the past. According to such a configuration, for example, it is possible to avoid the occurrence of a situation in which the communication system 1 does not operate normally due to issuing a plurality of certificates for the same public key. Further, by using the above described issuance history information, it is possible to prevent a replay attack such as erroneous issuance of a public key certificate or transmission of the same certificate signing request to the certificate authority 30 a plurality of times.

In addition, in the present embodiment, as described above, since the communication with the server device 40 is executed in a case where the edge device 10 is authenticated by executing the device authentication process on the edge device 10 using the public key certificate registered in the edge device 10, it is possible to provide the IoT service with a reduced security risk.

Note that the present embodiment may be configured to be able to realize the issuance and registration of the public key certificate of the edge device 10 in the factory shipment state using the user terminal 20, and for example, a part of the configurations of the communication system 1, the edge device 10, the user terminal 20, and the certificate authority 30 described in the present embodiment may be omitted, or other configurations may be added.

Next, another embodiment will be described. In the this embodiment, detailed description of the same parts as those in the first embodiment described above will be omitted, and parts different from those in the first embodiment will be mainly described.

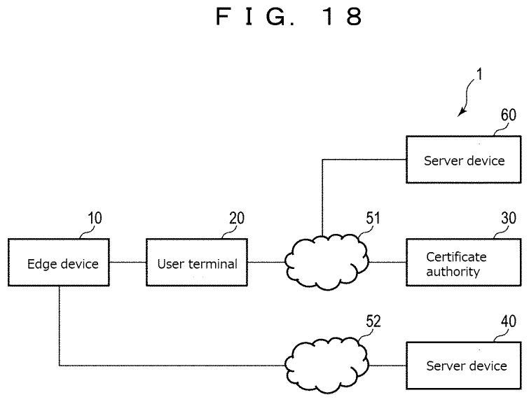

FIG. 18 shows an example of a system configuration of a communication system according to the present embodiment. As shown in FIG. 18, the communication system 1 further includes a server device 60 different from the server device 40, as compared with the first embodiment described above. In the present embodiment, for convenience of description, the server device 40 illustrated in FIG. 18 is described as a first server device 40, and the server device 60 is described as a second server device 60.

The second server device 60 is configured to execute a user authentication process for a user who owns the edge device 10 (a user who uses the user terminal 20).

The user terminal 20 and the second server device 60 illustrated in FIG. 18 are communicably connected to each other via a network 51.

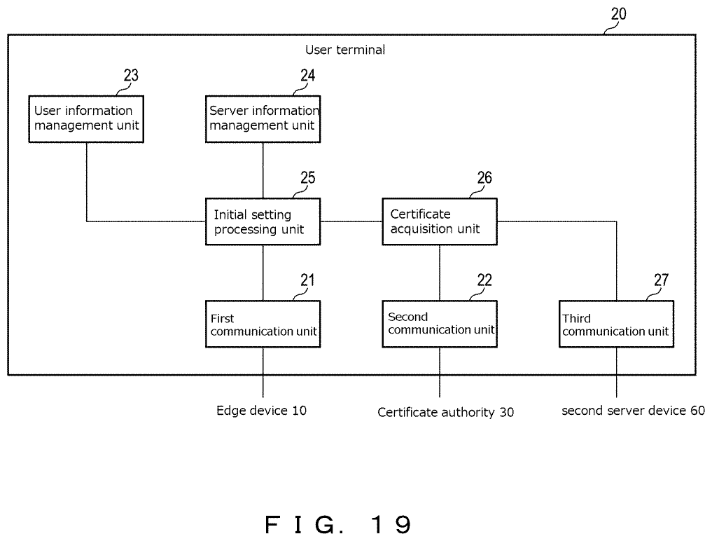

FIG. 19 shows an example of a functional configuration of the user terminal 20 in the present embodiment. As shown in FIG. 4, the user terminal 20 further includes a third communication unit 27, as compared with the first embodiment described above.

The third communication unit 27 communicates with the second server device 60 via the network 51. Note that, although the first communication unit 21, the second communication unit 22, and the third communication unit 27 are shown as independent and separate functional units in FIG. 19, the first communication unit 21, the second communication unit 22, and the third communication unit 27 may be realized as a single functional unit. The communication scheme for the first communication unit 21 to perform communication, the communication scheme for the second communication unit 22 to perform communication, and the communication scheme for the third communication unit 27 to perform communication may be different from each other or may be the same.

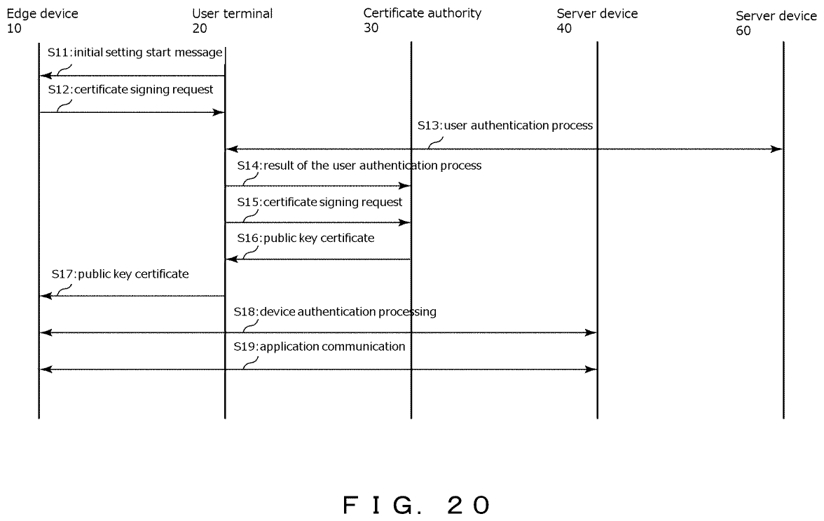

Hereinafter, an example of a processing procedure of the communication system 1 according to the present embodiment will be described with reference to a sequence chart of FIG. 20.

First, the processing of steps S11 and S12 corresponding to the processing of steps S1 and S2 shown in FIG. 9 described above is executed.

In the first embodiment described above, the user authentication process is performed between the user terminal 20 (certificate acquisition unit 26) and the certificate authority 30. In the present embodiment, however, that the second server device 60 performs the user authentication process instead of the certificate authority 30.

In this case, the certification acquisition unit 26 included in the user terminal 20 executes the user authentication process with the second server device 60 (step S13). The user authentication process is the same as that described in the first embodiment, and a detailed description thereof will be omitted. Further, there is a case where a process of exchanging a message for starting the certification issuing process between the user terminal 20 and the certification authority 30 is inserted between the steps S12 and S13, but the detailed description thereof will be omitted.

When the process of step S13 is executed, the certification acquisition unit 26 transmits the result of the user authentication process to the certificate authority 30 via the second communication unit 22 (step S14).

When the user is authenticated based on the result of the user authentication process transmitted in step S14, the process of steps S15 to S19 corresponding to the process of steps S4 to S8 shown in FIG. 9 described above is executed.

In the present embodiment, the second server device 60 performs the user authentication process by the certificate authority 30 instead of the certificate authority 30, and thus, for example, the processing load of the certificate authority 30 can be reduced, or the certificate authority 30 does not need to manage the authentication information of the user.

In the present embodiment described above, the user authentication process is executed between the user terminal 20 and the second server device 60. However, the user authentication process may be executed by, for example, the certificate authority 30 transferring a request for user authentication from the user terminal 20 to the second server device 60 (that is, the certificate authority 30 requesting the second server device 60 to execute the user authentication process). The user authentication process may be executed using, for example, OAuth2 authentication and authorization or the OpenID Connect mechanism.

Further, in the present embodiment, for example, a part of the configuration of the certificate authority 30 described in the first embodiment may be arranged in the second server device 60. Specifically, for example, the verification information management unit 32 included in the certificate authority 30 may be arranged in the second server device 60. According to such a configuration, for example, when the user is authenticated by executing the user authentication process between the user terminal 20 and the second server device 60, the verification information is provided from the second server device 60 to the certificate authority 30, and the certificate authority 30 can verify the certificate signing request based on the verification information provided from the second server device 60.

Next, a further embodiment will be described. In the present embodiment, detailed description of the same parts as those in the first embodiment described above will be omitted, and parts different from those in the first embodiment will be mainly described.

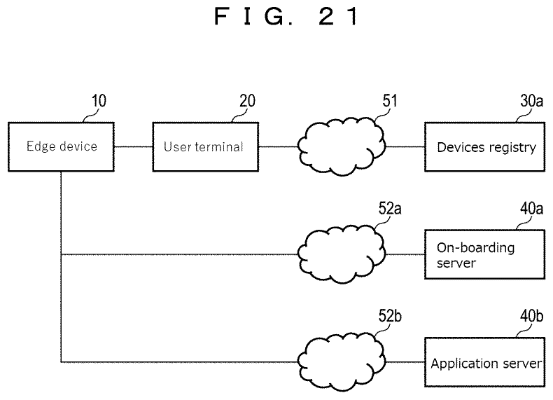

FIG. 21 shows an example of a system configuration of a communication system according to the present embodiment. As shown in FIG. 21, the communication system 1 includes a devices registry 30a instead of the certificate authority 30, and an on-board server 40a and an application server 40b instead of the server device 40, as compared with the first embodiment.

The devices registry 30a serves as the certificate authority 30 described in the first embodiment. That is, the devices registry 30a issues public key certificates of the edge devices 10 through communication with the user terminals 20 communicably connected via the network 51. The devices registry 30a generates information such as identifiers used by the edge devices 10 in communication with the on-boarding server 40a (hereinafter referred to as attribute information of the edge devices 10). The attribute information of the edge devices 10 generated in this way is managed in the devices registry 30a.

The on-boarding server 40a and the application server 40b serve as the server device 40 described in the first embodiment. The on-boarding server 40a is communicably connected to the edge devices 10 via the network 52a. The application server 40b is communicably connected to the edge devices 10 via the network 52b. The networks 52a and 52b may be the same networks as the network 52 described in the first embodiment.

The edge devices 10 acquire the attribute information of the edge devices 10 managed in the devices registry 30a together with the public key certificates of the edge devices 10 described above via the user terminals 20. The edge devices 10 communicate with the on-boarding server 40a using the acquired public key certificates and attribute information of the edge devices 10. The on-boarding server 40a holds various kinds of information (hereinafter, referred to as communication execution information) necessary for the edge devices 10 to execute communication with the application server 40b, and operates to provide the communication execution information to the edge devices 10.

The application server 40b operates to start communication (application communication) with the edge devices 10 using the communication execution information provided from the on-boarding server 40a to the edge devices 10 and provide the IoT service.

The registration of the attribute information of the edge devices 10 managed in the above-described devices registry 30a and the communication execution information held in the on-boarding server 40a may be performed using the user terminals 20, for example, or may be performed in advance by another method.

The operation of the communication system 1 according to the present embodiment is the same as that described in the first embodiment except that the devices registry 30a is disposed instead of the certificate authority 30 in the first embodiment described above, and the on-boarding server 40a and the application server 40b are disposed instead of the server device 40 in the first embodiment, and therefore, the detailed description thereof is omitted here.

As described above, in the present embodiment, even in the communication system 1 having the configuration as shown in FIG. 21, it is possible to easily issue and register a public key certificate to the edge device 10 in the factory shipment state, similarly to the first embodiment described above.

According to at least one of the embodiments described above, it is possible to provide a communication system, a terminal device, a communication device, and a method capable of easily issuing and registering a certificate used for communication.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. These embodiments and modifications thereof are included in the scope and spirit of the invention, and are also included in the subject matter described in the claims and the scope of equivalents thereof.

The functionality of the elements disclosed herein may be implemented using circuitry or processing circuitry which includes general purpose processors, special purpose processors, integrated circuits, ASICS (“Application Specific Integrated Circuits”), FPGAS (“Field-Programmable Gate Arrays”), conventional circuitry and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

The disclosure includes a memory that stores a computer program m which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of a FPGA or ASIC.

### DESCRIPTION OF SYMBOLS

1. communication system, 10. edge devices (communication devices, communication circuitry, or communicator), 10a. processor, 10b. nonvolatile memory, 10c. main memory, 10d. communication interface, 11. first communication unit, 12. second communication unit, 13. request generation unit, 14. device-information management unit, 15. key management unit, 16. registration unit, 17. application processing unit, 20. user terminals (terminals), 21. first communication unit, 22. second communication unit, 23. user-information management unit, 24. server-information management unit, 25. initial setting processing unit, 26. certificate acquisition unit, 27. third communication unit, 30. certificate authority, 31. communication unit, 32. verification information management unit, 33. request verification unit, 34. certificate issuance unit, 35. issuance-history management unit, 30a. device registry, 40. server device (first server device), 40a. on-boarding server, 40b. application server, 51, 52, 52a, 52b. network, 60. server device (second server device).

What is claimed is:

1. A communication system, comprising:
communication circuitry;
a terminal; and
a certificate authority,
wherein:
the communication circuitry is configured to transmit, to the terminal, a certificate signing request for requesting issuance of a certificate used for the communication circuitry to communicate with a first server,
the terminal includes circuitry configured to transmit the certificate signing request transmitted from the communication circuitry to the certificate authority,
the certificate authority includes circuitry configured to issue the certificate in response to the certificate signing request transmitted from the terminal,
the certificate authority includes circuitry configured to transmit the certificate issued by the certificate authority to the communication circuitry via the terminal, and
the communication circuitry is further configured to register the certificate issued by the certificate authority.

2. The communication system according to claim 1, wherein:
the certificate includes a certificate for a public key of the communication circuitry in a public key encryption scheme.

3. The communication system according to claim 1, wherein:
the terminal further includes circuitry configured to instruct the communication circuitry to generate the certificate signing request when the communication circuitry and the terminal are communicably connected, and
the communication circuitry is further configured to generate the certificate signing request in response to an instruction from the terminal.

4. The communication system according to claim 1, wherein:
the terminal further includes circuitry configured to transmit user information of a user who owns the communication circuitry and server information of the first server to the communication circuitry, and
the user information and the server information transmitted from the terminal are set in the communication circuitry.

5. The communication system according to claim 1, wherein:
the certificate signing request includes device information about the communication circuitry; and
the certificate authority further includes circuitry configured to verify the certificate signing request based on device information included in the certificate signing request, and issue the certificate when the verification of the certificate signing request is successful.

6. The communication system according to claim 1, wherein:
the certificate signing request includes an electronic signature generated by the communication circuitry, and
the terminal or the certificate authority includes circuitry configured to verify the certificate signing request by using an electronic signature attached to the certificate signing request.

7. The communication system according to claim 1, wherein:
the certificate includes an electronic signature generated by the certificate authority, and
the terminal or the communication circuitry includes circuitry configured to verify the certificate by using an electronic signature attached to the certificate.

8. The communication system according to claim 1, wherein:
the certificate authority includes circuitry configured to issue the certificate when a user who owns the communication circuitry is authenticated by executing an authentication process for the user between the terminal and the certificate authority.

9. The communication system according to claim 1, wherein:
the certificate authority includes circuitry configured to issue the certificate when a user who owns the communication circuitry is authenticated by executing an authentication process for the user between the terminal and a second server.

10. The communication system according to claim 1, wherein:
the certificate authority includes circuitry configured to determine whether to issue the certificate based on issue history information regarding certificates issued in the past.

11. The communication system according to claim 1, wherein:
the communication circuitry performs communication with the first server when the communication circuitry is authenticated by performing an authentication process on the communication circuitry using the registered certificate.

12. A terminal device comprising:
a first receiver to receive, from communication circuitry, a certificate signing request for requesting issuance of a certificate used by the communication circuitry to communicate with a first server;
a first transmitter to transmit the received certificate signing request to a certificate authority;
a second receiver configured to receive, from the certificate authority, a certificate issued by the certificate authority in response to the certificate signing request; and
a second transmitter to transmit the certificate received from the certificate authority to the communication circuitry, the certificate being for registration in the communication circuitry.

13. A communication device comprising:
a transmitter to transmit, to a terminal, a certificate signing request for requesting issuance of a certificate used for performing communication with a first server;
a receiver to receive, from a certificate authority via the terminal, a certificate issued by the certificate authority in response to a certificate signing request transmitted from the terminal to the certificate authority;
registration circuitry configured to register the received certificate.

14. A method executed by a communication system including communication circuitry, a terminal, and a certificate authority, the method comprising:
transmitting, from the communication circuitry to the terminal, a certificate signing request for requesting issuance of a certificate used for the communication circuitry to communicate with a first server;
transmitting, from the terminal to the certificate authority, a certificate signing request transmitted from the communication circuitry;
issuing, by the certificate authority, the certificate in response to a certificate signing request transmitted from the terminal;
transmitting the certificate issued by the certificate authority to the communication circuitry via the terminal; and
registering the certificate in the communication circuitry.

15. The method according to claim 14, wherein:
the certificate includes a certificate for a public key of the communication circuitry in a public key encryption scheme.

16. The method according to claim 14, further comprising:
instructing, by the terminal, the communication circuitry to generate the certificate signing request when the communication circuitry and the terminal are communicably connected, and
generating, by the communication circuitry, the certificate signing request in response to the instructing by the terminal.

17. The method according to claim 14, further comprising:
transmitting, by the terminal, user information of a user who owns the communication circuitry and server information of the first server to the communication circuitry; and
setting, in the communication circuitry, the user information and the server information transmitted from the terminal.

18. The method according to claim 14, wherein:
the certificate signing request includes device information about the communication circuitry,
the method further comprising verifying, by the certificate authority the certificate signing request based on device information included in the certificate signing request, and issuing the certificate when the verification of the certificate signing request is successful.

19. A method comprising:
receiving, from communication circuitry, a certificate signing request for requesting issuance of a certificate used for the communication circuitry to perform communication with a first server;
transmitting the received certificate signing request to a certificate authority;
receiving, from the certificate authority, a certificate issued by the certificate authority in response to the certificate signing request; and
transmitting a certificate received from the certificate authority to the communication circuitry for registration in the communication circuitry.

20. A method comprising:
transmitting, to a terminal, a certificate signing request for requesting issuance of a certificate used for performing communication with a first server;
receiving, via the terminal, a certificate issued by a certificate authority in response to a certificate signing request transmitted from the terminal to the certificate authority; and
registering the received certificate.
